(19) United States
(12) Patent Application Publication
(10) Pub. No.: US 2023/0397754 A1
(43) Pub. Date: Dec. 14, 2023

(54) BEVERAGE PREPARATION MACHINE WITH SILICONE DRIP GRID

(71) Applicant: Tchibo GmbH, Hamburg (DE)

(72) Inventors: Alexander Erdwiens, Darmstadt (DE); Micha Daniels, Sulzbach (DE)

(21) Appl. No.: 18/249,588

(22) PCT Filed: Oct. 20, 2021
(86) PCT No.: PCT/EP2021/079068

§ 371 Date: Apr. 19, 2023

(30) Foreign Application Priority Data
Oct. 21, 2020 (EP) 20203145.6

(51) Int. Cl. A47J 31/44; A47J 31/40

(52) U.S. Cl. CPC A47J 31/4428; A47J 31/407

(57) ABSTRACT

A beverage preparation machine that has an outlet for dispensing a prepared beverage, a receiving area for receiving a vessel for receiving the prepared beverage, and a platform that delimits the receiving area on the side opposite the outlet, and on which the vessel can be placed while the beverage is being prepared. The platform is at least partly made of an elastomer.

### BACKGROUND OF THE INVENTION

### Field of the Invention

The invention relates to a beverage preparation machine, in particular a capsule coffee machine, with an outlet for dispensing a prepared beverage and a receiving area located below the outlet for receiving a vessel for receiving the prepared beverage. The receiving area is delimited on the side opposite the outlet, i.e. downwards, by a platform on which the vessel can be placed during preparation of the beverage.

### Description of Related Art

Known capsule coffee machines are equipped with a collection receptacle for catching liquid dispensed from the outlet and not received by a vessel. This can for example be flushing fluid used for cleaning the capsule coffee machine, coffee which goes on dripping out after the vessel is removed or surplus coffee spilled when a too small vessel is used. A platform placed loosely on the collection receptacle, in particular a so-called drip grid, is usually provided on which the vessel can be placed during preparation of the beverage.

In known capsule coffee machines, such as the one described in the document EP 3 205 245 A1, the drip grid is usually made of metal or plastic. This has the disadvantage that loud and thus annoying noises can occur when the vessel is placed on the drip grid. Another disadvantage is that in particular drip grids made of metal can easily be scratched by the vessels, thus impairing the appearance and durability of the drip grids.

### SUMMARY OF THE INVENTION

The object of the present invention is to suggest a beverage preparation machine with low noise and high durability.

According to the present invention, the beverage preparation machine is equipped with an outlet for dispensing a prepared beverage, a receiving area for receiving a vessel for receiving the prepared beverage, and a platform which delimits the receiving area on the side opposite the outlet and on which the vessel can be placed during preparation of the beverage. The platform is at least partly made of an elastomer. In particular, at least the part of the platform on which the vessel is placed is made of the elastomer.

A platform, in particular a drip grid, which is made of an elastomer has the advantage that much less noise is caused when the vessel is placed on it than would be the case with a usual drip grid made of metal or plastic. Also, platforms made of an elastomer cannot be scratched.

The platform is made entirely of the elastomer, thus allowing simple one-piece production and ensuring that the platform as a whole cannot be scratched.

In an alternative embodiment, it is possible that only part of the platform, i.e. the section on which the vessel is placed, is made of the elastomer.

In particular, the platform features a supporting frame which is at least partly, preferably completely, coated with the elastomer (thus forming at least the mentioned section on which the vessel is placed). The frame in particular serves to give the platform a stable, constant shape and is made of a non-elastic material such as metal or plastic. This ensures the stability of the platform, while the elastomer coating prevents scratching and provides a cushioning effect.

The elastomer preferably includes a natural rubber, at least one silicone rubber, at least one silicone, at least one silicone resin, and/or a fluorosilicone. It is also possible to use other elastomers as alternatives.

In one embodiment of the invention, the platform consists entirely of a silicone. Silicones are especially durable and are easy to mould into the desired shapes.

It is especially advantageous if the platform is formed as a single piece. This ensures easy handling. In particular to allow a collection receptacle located below the platform to be emptied, it must be possible to detach the platform from the collection receptacle, something which is much easier to do with a platform formed as a single piece than it is with a platform consisting of several pieces.

In a preferred embodiment of the invention, the platform is equipped with at least one opening. The platform is preferably equipped with several openings. Through these openings, liquid issuing from the outlet and not received by the vessel can flow into a collection receptacle located below the platform.

The platform can in particular have a grid-like structure. Herein, the openings are in particular slit-like in shape and are arranged parallel to each other.

In particular, the platform has a thickness of at least 5 mm, preferably between 5 and 20 mm, and for example between 10 and 20 mm. Silicone is considerably softer and more elastic than metal or plastic. To be able to achieve sufficient stability nevertheless, it is advantageous if the platform has the mentioned thicknesses and/or if it includes the supporting frame of a for example non-elastic material. This in particular prevents the vessel placed on the platform from overturning.

The beverage preparation machine can in particular include a collection receptacle for catching liquid issuing from the outlet, the platform being located between the collection receptacle and the receiving area.

The collection receptacle in particular includes at least one supporting element, preferably several, on which the platform can be placed. This makes the platform especially easy to mount.

The beverage preparation machine is in particular a coffee machine, preferably a capsule coffee machine.

### BRIEF DESCRIPTION OF THE DRAWING

Other features and advantages of the invention result from the following description, which explains the invention in more detail by way of example embodiments with reference to the accompanying FIGURE.

There is shown in:

FIG. 1 a schematic perspective view of a capsule coffee machine.

### DETAILED DESCRIPTION OF THE INVENTION

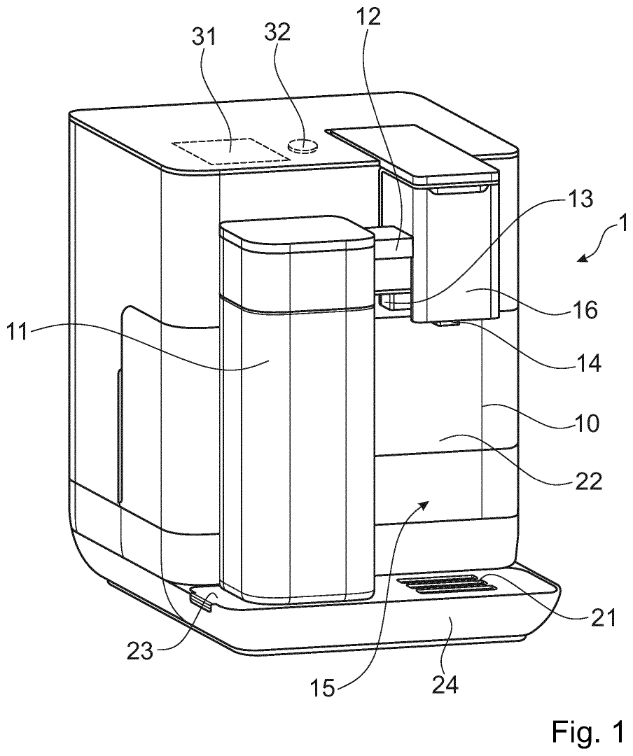

FIG. 1 shows a schematic perspective view of the beverage preparation machine 1, configured as a capsule coffee machine.

The beverage preparation machine 1 includes a basic unit 10 and a milk frother 11, which can be coupled with the basic unit 10 and which serves as a milk module. A docking element 12 of the kind described in WO 2016/046239 accesses relevant interfaces of the basic unit, supplies water, steam and possibly air from the basic unit to the milk frother, also forms an electrical connection to the voltage supply and/or transfers control signals coming from active elements (in particular a pump) of the milk frother. Moreover, the docking element forms a milk outlet 13 which, in the docked state, is located next to the outlet for brewed beverages (the coffee outlet 14 in this case) of the basic unit 10.

The basic unit 10 is equipped with a water tank, a water pump and a water heater. Moreover, it is equipped with a brewing chamber for preparing coffee from heated water by way of extraction from ground coffee powder supplied in the form of a portion capsule, which is inserted into the coffee machine before the beverage is prepared. As an alternative to the displayed embodiment as a portion capsule system, the coffee machine can also take the form of a so-called fully automatic coffee machine, which is additionally equipped with a coffee mill by means of which it grinds the coffee one portion at a time before supplying it to the brewing chamber. As yet another alternative—especially if the coffee machine is formed as a plunger machine in which the brewing chamber is located between a fixed section and a removable plunger—the user can be intended to feed the coffee into the brewing chamber in the ground state, but in bulk.

Moreover, the coffee machine 1 can also be equipped with a collection receptacle 24 for used portions of ground coffee powder (in capsules or in bulk, depending on the design of the coffee machine). The coffee machine is equipped with a platform 21 on which to place a drinking vessel. There is a collection tray located below the platform 21.

Above the platform 21 is the coffee outlet 14 from which the brewed coffee issues before entering the vessel situated below the outlet. The coffee outlet is located below an outlet cover 16, which forms part of the coffee machine housing and at least partly covers the outlet to the front and to the sides.

The platform 21 is at least partly made of an elastomer. This has the advantage that much less noise is caused when the vessel is placed on it than would be the case with a usual platform made of metal or plastic. In addition, platforms 21 made of an elastomer cannot be scratched. The elastomer used is a silicone in particular.

The platform 21 is equipped with several openings through which the liquid issuing from the outlet 14 and not received by the vessel flows into the collection receptacle 24. The openings are slit-like in shape and are arranged parallel to each other. Alternatively, the openings can have other shapes and configurations.

The basic unit 10 forms a front panel 22 from which, as is well known from other coffee machines, the platform 21 and the outlet cover 16 located above it protrude.

A milk frother platform 23 on which the docked milk frother 11 is placed also protrudes from the front panel here.

In the vicinity of the coffee outlet 14, and at the side of the outlet cover 16 in this case, there is an interface for connecting the docking element to the coffee machine. This interface is equipped with a steam delivery point for coupling with a steam connection of the docking element and possibly also a hot water and/or steam delivery point for coupling with a bypass for a cleaning fluid (hot water/steam) for the milk frother. When required, the steam delivery point and the hot water and/or steam delivery point are supplied with steam and/or hot water by the water heater, whereby for example a selector valve located inside the coffee machine can supply heated liquid and/or steam optionally to the brewing module, the steam delivery point or the hot water and/or steam delivery point. Moreover, there is a display 31 and a control element 32, both of which are located on the basic unit 10 in the example embodiment shown here.

The control element 32 is a physical control element which in this case takes the form of a combined dial/pushbutton like those known from many household appliances. The combined dial/pushbutton can be programmed in such a way that, by turning the dial, the user can select between various available elements (different menu items, different preparation rules, different quantities of beverage expressed as individual steps), and, by pressing the combined dial/pushbutton in an axial direction, cause the current selection to be confirmed via the display.

Other control elements combinations of control elements or integrated solutions are conceivable, too, for example with a touchscreen which forms the display as well as the control element. In the present example embodiment, and generally frequently preferred, the beverage preparation machine is designed as a fully functional standalone unit operable without the external operating unit described in the following, which means that all inputs and information outputs which are actually necessary for operation can be effected using the unit's own user interface, something which does not rule out the possibility that, optionally, certain functionalities not necessary for operation, such as the setting of relative quantities, may require an entry to be made via the operating unit.

Moreover, the basic unit (capsule coffee machine) is in this case designed in such a way that it can also be operated without the milk module, whereby the presence or absence of the milk module is preferably detectable and the corresponding (milk) functions are only available when the milk module is connected.

### LIST OF REFERENCE SIGNS

1 Beverage preparation machine
10 Basic unit
11 Milk frother
12 Docking element
13 Milk outlet
14 Coffee outlet
15 Receiving area
16 Outlet cover
21 Platform
22 Front panel
23 Milk frother platform
31 Display
32 Control element

1. A beverage preparation machine,
with an outlet for dispensing a prepared beverage,
a receiving area for receiving a vessel for receiving the prepared beverage,
a platform which delimits the receiving area on the side opposite the outlet and on which the vessel can be placed while the beverage is being prepared,
wherein at least a section of the platform on which the vessel is placed during preparation of the beverage is made of an elastomer.

2. The beverage preparation machine according to claim 1, wherein the platform is made entirely of the elastomer.

3. The beverage preparation machine according to claim 1, wherein the elastomer comprises at least one natural rubber, at least one silicone rubber, at least one silicone, at least one silicone resin and/or at least one fluorosilicone.

4. The beverage preparation machine according to claim 1, wherein the platform is made of a silicone.

5. The beverage preparation machine according to claim 1, wherein the platform is formed as a single piece.

6. The beverage preparation machine according to claim 1, wherein the platform is equipped with at least one opening.

7. The beverage preparation machine according to claim 6, wherein the platform is equipped with several openings.

8. The beverage preparation machine according to claim 1, wherein the platform has a grid-like structure.

9. The beverage preparation machine according to claim 1, wherein the platform has a thickness of at least 5 mm.

10. The beverage preparation machine according to claim 9, wherein the platform has a thickness of at least 10 mm.

11. The beverage preparation machine according to claim 10, wherein the platform has a thickness of at least 20 mm.

12. The beverage preparation machine according to claim 1, wherein the beverage preparation machine includes a collection receptacle for catching liquid issuing from the outlet, and that the platform is located between the collection receptacle and the receiving area.

13. The beverage preparation machine according to claim 12, characterized in that the collection receptacle includes supporting elements on which the platform can be placed.

14. The beverage preparation machine according to claim 1, wherein the beverage preparation machine is a coffee machine.

15. The beverage preparation machine according to claim 14, wherein the beverage preparation machine is a capsule coffee machine.
